(19) United States
(12) Patent Application Publication
(10) Pub. No.: US 2018/0150627 A1
(43) Pub. Date: May 31, 2018

(54) Authentication using multi-component swipe pattern and color, sound or symbol series unlocking patterns and or codes

(71) Applicant: Benjamin Rodefer, Corrales, NM (US)

(72) Inventor: Benjamin Rodefer, Corrales, NM (US)

(21) Appl. No.: 15/365,324

(22) Filed: Nov. 30, 2016

(51) Int. Cl. G06F 21/36

(52) U.S. Cl. CPC G06F 21/36; G06F 3/04886

(57) ABSTRACT

Authentication using multi-component swipe pattern and color, sound or symbol series unlocking patterns and or codes

### TECHNICAL FIELD

This document generally relates to physical and data security for computing devices, and more specifically for enhanced multi-component user authentication.

### BACKGROUND

A computing system or device can be in a locked state, whereby a user is not able to access the system or certain restricted features or portions of the system without accomplishing or entering some required authentication or passcode.

### SUMMARY

This document describes systems and methods, including computer programs encoded on computer storage media, for presenting, whether user or system defined, by a computing system that is locked, a multi-component unlock code, pattern or method of authentication and then receiving return input from a user correctly unlocking or authenticating access to the locked computing system or restricted features thereof based on the system presented multi-component unlock code, pattern or method of authentication.

### BRIEF DESCRIPTION OF THE DRAWINGS

FIG. 1 Shows one possible embodiment of a multi-component authentication interface. Some may include greater or fewer numbers of individual authentication components (in this case a central swipe pattern screen, a numeric/symbol upper component and a lower musical not/tone component) and the various authentication components may be arranged on the screen in any and many various manners (the numeric/symbol keys could be in the four corners, or arranged out around the exterior for example).

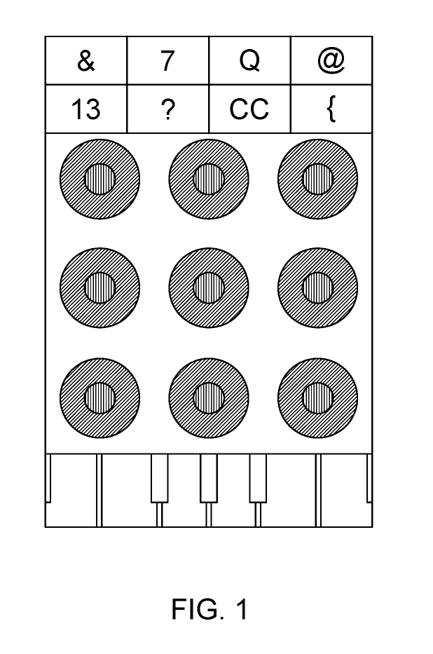

FIG. 2 Shows an alternate example of an embodiment of a multi-component authentication interface. In this instance not that the swipe pattern buttons do not have to be organized in any strict grid pattern but may be freely arranged on the screen and in any number two or greater. At bottom is one possible embodiment of a color or gray scale authentication component, such component possibly being made up of any number of differing colors or gray scale or other tonal variations. This example illustrates one containing four different colors or shades.

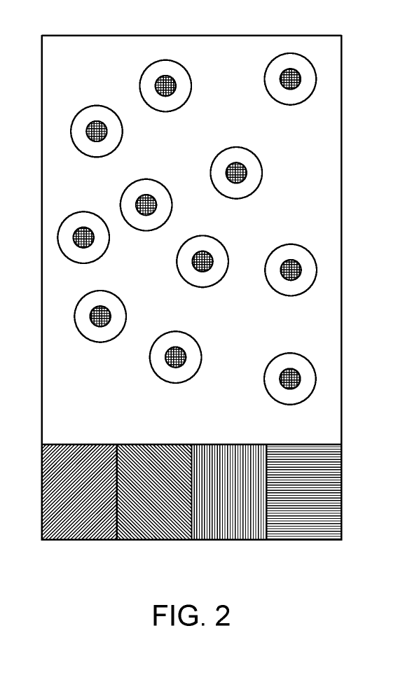

FIGS. 3 & 4 Shows one possible example where the swipe pattern/code is entered or revealed and has two distinct colors or shades. In this example it is the same swipe pattern repeated but with two distinct colors or shades. Possible variations may include longer or shorter series of varying or constant swipe patterns and color/shade combinations. Other authentication components may be included as well, for example a different sound or note or tone with each input or revealed example. The swipe pattern and other component(s) for authentication to be entered by any current means of user entry, whether by finger touch, stylus or any other current or future method.

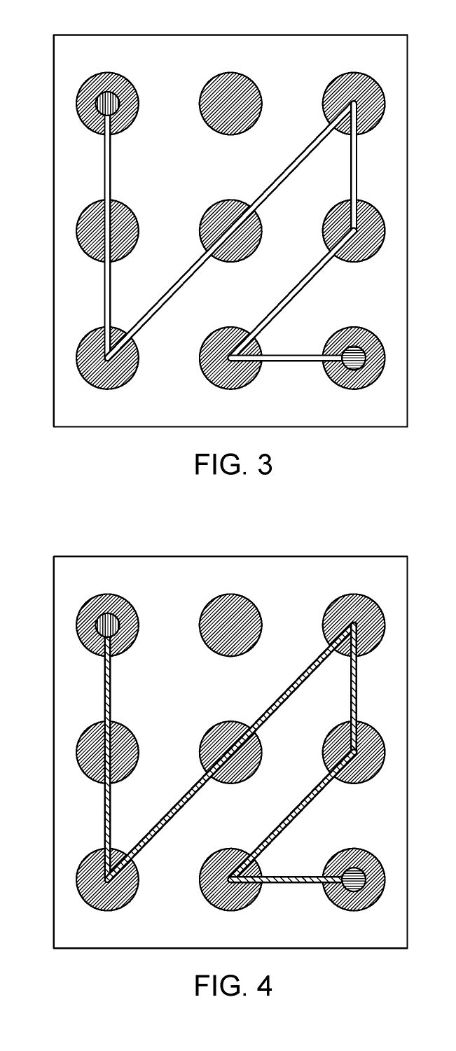

FIGS. 5 & 6 Show a further possible example similar to FIGS. 3 & 4 but in this case a different number, letter or other symbol is also required, input or revealed with each separate revealed or input example of the multi-component authentication, and is a required component for authentication. Also note in this example that the beginning and ending buttons of the swipe pattern are of different colors or shades indicating in which direction the swipe pattern was or is to be completed. Such indication may also be accomplished by other methods, including but not limited to having a symbol, letter, number or color/shade on or near the first or last button in the swipe pattern, or having the first or last button designated or pre-defined in some other manner, for example the first button in a series of swipe patterns may begin at the upper left most button but then progress in some user or system defined pattern for each progressive swipe pattern in the series.

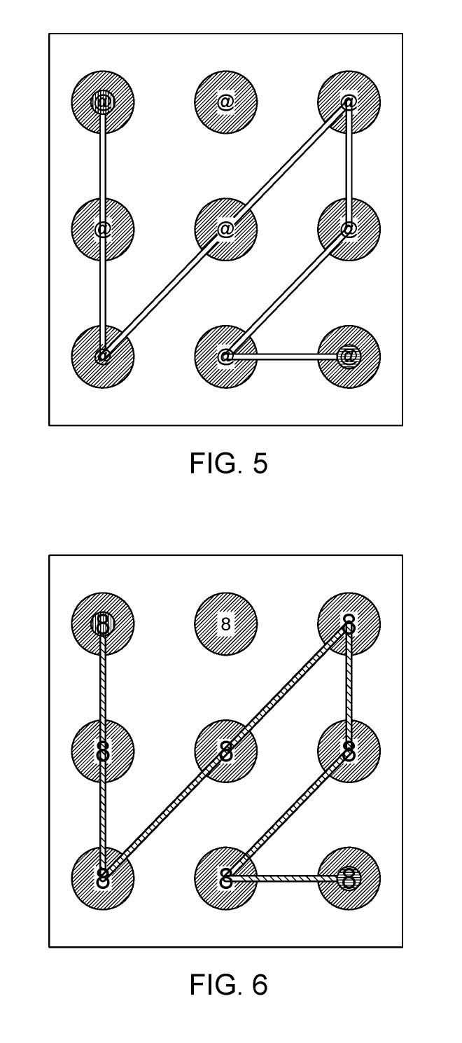

FIG. 7 Shows an example with two additional components, one being a time limitation for the completion of the multi-component authentication with one embodiment of a timer shown at bottom. Second, a symbol or other notation, in this case an arrow, may indicate that this swipe pattern must indeed be input in a different orientation or manner. In this example the arrow may indicate “up” and thus that for the true authentication pattern to be entered successfully the input or revealed swipe pattern component must in this example be rotated 90 degrees clockwise.

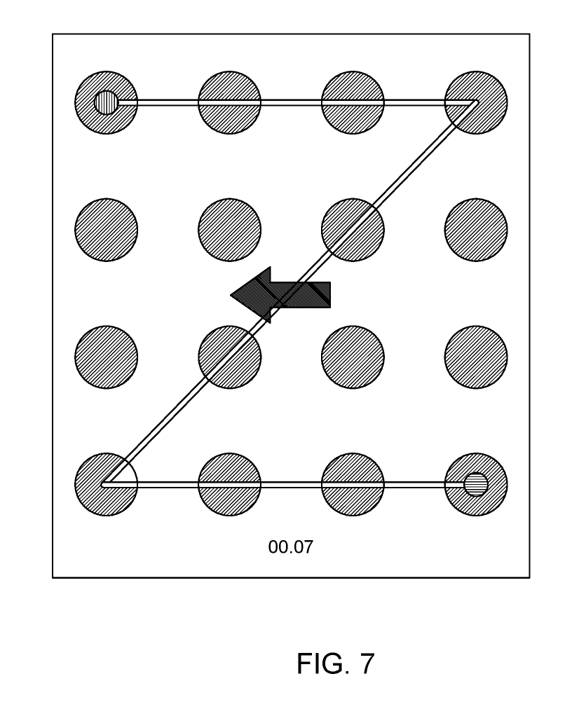

FIG. 8 Shows a different example of a possible timer and also a different symbol or other method of conveying that the swipe pattern must indeed be input in a different orientation or manner to be successful. In this example perhaps the swipe pattern is to be successfully entered as a mirror reverse of what is actually shown.

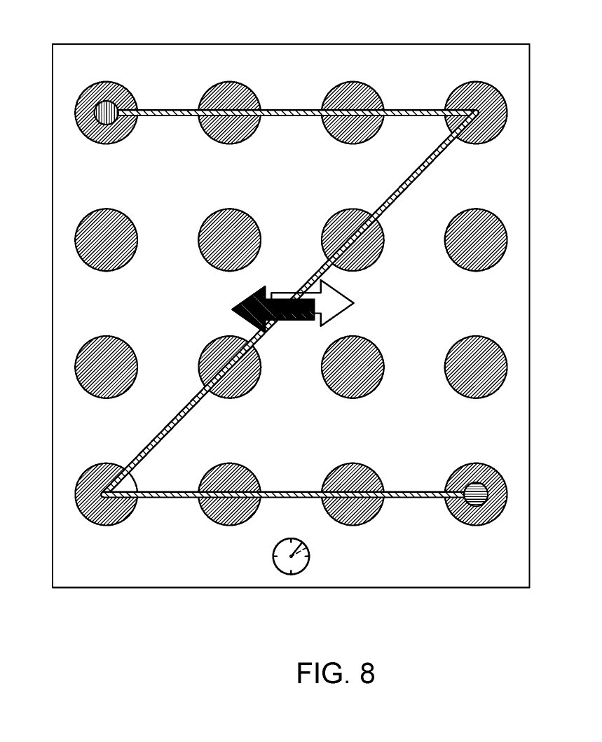

1. A user authentication or unlock method for use on a computing device comprised of inputting a system generated and revealed hand-drawn combination pattern and color password via a touch panel, comprising the steps of:
(a) providing an array or multiple arrays of input keys on a touch panel, with each of the input keys representing a character, numeral, color, sound or symbol;
(b) revealing to the user a system generated multi-component authentication or unlock code, such authentication or unlock code comprising a sequence of one or more hand-drawn pattern passwords each presented to the user in a distinct or repeated color or gray scale value or series thereof.
(c) a user touching and sliding their finger or stylus over a sequence of some or all of the input keys on the touch panel thereby drawing the pattern password or pattern passwords revealed in (b) above and then, in the specified order, entering the colors or gray scale values revealed in (b), whether on the same or a separate touch panel input array.

2. The multi-component user authentication or unlock method as claimed in claim 1, wherein the hand-drawn pattern password(s) are each presented with a different symbol, character or audible sound instead of a different color or gray scale shade, thus the inputting of the so presented symbols, characters or sounds in the specified order then makes up the second step of the authentication or unlock method as described in claim 1 (c).

3. The system or method of claims 1 and 2 whereby the color, gray scale value, symbol, character or sound component of the revealed authentication or unlock code and the corresponding hand drawn pattern password or passwords are entered or input in a different system determined and specified order or sequence.

4. The system or method of the above claims whereby there are three or more revealed components to the authentication or unlock method, including at least one hand-drawn pattern password and two or more color, gray scale value, sound, symbol or character pattern passwords.

5. The system or method of the above claims whereby the system reveals that the true and correct authentication or unlock code(s), pattern(s) or password(s) must be entered in a different manner, order or configuration than what was actually shown. Examples might include requiring the user to enter the mirror image or a 90 degree rotated version of a hand-drawn password or passwords, or the reverse of a color series or symbol or sound password, or the same password but omitting any of a specific color or symbol or sound.

6. The system or method of the above claims whereby a user must correctly input a series or sequence of such multi-component authentication or unlock codes or passwords in order to authenticate and or unlock the data or content or digital access controlled by said authentication or unlock codes or passwords.

7. The system or method of the above claims whereby there is a time component limiting the time in which the user has to successfully enter the system revealed multi-component authentication or unlock code or passwords, or series or sequence thereof.

8. The system or method of the above claims whereby one of or both of the starting and finishing points of the hand drawn pattern password(s) is indicated, thus allowing the user to know in which order or direction the hand drawn pattern password(s) is to be entered.

9. A user authentication or unlock method for use on a computing device comprised of inputting a previously user or system determined hand-drawn combination pattern and color password via a touch panel, comprising the steps of:
(a) providing an array or multiple arrays of input keys on a touch panel, with each of the input keys representing a character, numeral, color, sound or symbol;
(b) a user touching and sliding their finger or stylus over a sequence of some or all of the input keys on the touch panel thereby drawing the previously defined pattern password or pattern passwords and then, in the specified order, entering the colors or gray scale values also corresponding to the multi-component authentication or unlock code, whether on the same or a separate touch panel input array.

10. The multi-component user authentication or unlock method as claimed in claim 8, wherein the hand-drawn pattern password(s) are each presented with a different symbol, character or audible sound instead of a different color or gray scale shade, thus the inputting of the so presented symbols, characters or sounds in the specified order then makes up the second step of the authentication or unlock method as described in claim 1 (b).

11. The system or method of claims 8 and 9 whereby the color, gray scale value, symbol, character or sound component of the authentication or unlock code and the corresponding hand drawn pattern password or passwords are entered or input in a different user or system determined and specified order or sequence.

12. The system or method of the claims 8, 9 & 10 whereby there are three or more components to the authentication or unlock method, including at least one hand-drawn pattern password and two or more color, gray scale value, sound, symbol or character pattern passwords.

13. The system or method of the claims 8, 9, 10 & 11 whereby the system requests or reveals that the true and correct authentication or unlock code(s), pattern(s) or password(s) must be entered in a different manner, order or configuration than what was actually originally determined and defined. Examples might include requiring the user to enter the mirror image or a 90 degree rotated version of a hand-drawn password or passwords, or the reverse of a color series password, or the same password but omitting any blue.

14. The system or method of the claims 8-12 whereby a user must correctly input a series or sequence of such multi-component authentication or unlock codes or passwords in order to authenticate and or unlock the data or content or digital access controlled by said authentication or unlock codes or passwords.

15. The system or method of the claims 8-13 whereby there is a time component limiting the time in which the user has to successfully enter the multi-component authentication or unlock code or passwords, or series or sequence thereof.
